(19) United States
(12) Patent Application Publication
(10) Pub. No.: US 2017/0317878 A1
(43) Pub. Date: Nov. 2, 2017

(54) Universal Data Network and Constructing Method thereof and Generalized Computer System and Method for Constructing the Same

(71) Applicant: Jianchao GONG, Quzhou City (CN)

(72) Inventor: Jianchao GONG, Quzhou City (CN)

(21) Appl. No.: 15/523,264

(22) PCT Filed: Dec. 3, 2015
(86) PCT No.: PCT/CN2015/096322

§ 371 Date: Apr. 28, 2017

(30) Foreign Application Priority Data
Dec. 6, 2014 (CN) 201410731935.7

(51) Int. Cl. H04L 12/24

(52) U.S. Cl. CPC H04L 41/0803; H04L 41/0213; H04L 41/0246

(57) ABSTRACT

Provided is a universal data network and its construction method, and a generalized computer system and its construction method. A data transmission layer for performing human-computer interactions in an open network environment and a data domination layer for performing intelligent computer-computer cooperation in a closed network environment combine the universal data network. Intelligent elements and human-computer interaction elements are connected in a universal data network mode to form the generalized computer system. Software program codes of the universal data network only exist in the data domination layer, facilitating prevention of software piracy; and coexistence of multiple networks allows diversified development of commercial data services. Combination manner of the generalized computer system is flexible, and replacement and upgrading of devices of the generalized computer system can be smoothly and continuously performed during operation, for playing an important role in computer systems for military, industries, space navigation etc. having special requirements.

### TECHNICAL FIELD

The present invention relates to a universal data network and a constructing method thereof and a generalized computer system and a method for constructing the same.

### BACKGROUND ART

With rapid development of computer technologies and communication technologies, various intelligent electronic products and data terminals have been prevalent in various fields. Basic computer system hardware mainly comprise the following modes: a basic mode that comprises a central processing unit, a memory host (a central processing unit, a memory) and input and output devices, a variant mode of a small or micro all-in-one computer, and a variant mode of a split-type computer with part of hardware wirelessly installed in a separate way. Due to relatively fixed ways with which such computer system devices are utilized, it will be less flexible in using fashioned or variant computer-related devices widely emerging in future, such as intelligent digital devices, network devices, micro-sensors, etc., and this also poses security threats in this case.

### SUMMARY OF THE DISCLOSURE

In light of the foregoing problems, this disclosure presents concepts of a universal data transmission and domination network and a generalized computer system, applications of the universal data transmission and domination network and the generalized computer system in new intelligent services, and methods of constructing them, for the purpose of improving flexibility, security and effectiveness of use of information technologies. The intelligent service herein refers to a combination of three levels of data information services, the first-level service being a data transmission and storage service, the second-level service being a procedural application and information service, and the third-level service being a strategy service with artificial intelligence property. In the present context, data manipulation process of the intelligent services is named as data domination.

The present invention is directed to two concepts, namely, the generalized computer system and the universal data transmission and domination network, wherein the universal data transmission and domination network (hereinafter referred to as “universal data network”) is an important basis of the generalized computer system.

1. Definitions of a universal data network and a generalized computer system

1.1. The universal data network: a clearly-layered data network system formed by combining a data transmission layer and a data domination layer, wherein the data transmission layer provides data transmission services in an open network environment and accesses user equipment, the data domination layer as a whole provides uniform data domination capacities in a closed and independent network environment to achieve intelligent services, and when a device in the data transmission layer has data in a range of a data domination layer, its own device information and its own user permission information should be indicated.

In this layered mode, as long as intelligent service elements of the universal data network were protected in a closed network, the intelligent service elements can be centralized or decentralized in random spatial places or intelligent resource spaces. The universal data network is composed of a data transmission layer and a data domination layer together, the data transmission layer formed by data relay servers and data network interfaces, and the data domination layer constructed by individual levels of synchronous processing centers and a central server, wherein the data domination layer has one and single user with a highest permission. Ordinary users in the data transmission layer cannot perform operations to the data domination layer, with the operations directly orienting the original data or original program codes. The universal data network differs from common mobile data networks providing data transmission services in that: the data transmission layer of the universal data network adopts a data relay server connection mode managed by data network interfaces and can accept various wired or wireless network connections; and the data domination layer of the universal data network is equivalent to a separately installed or remotely installed combined host computer system having uniform user permissions, and can adopt universal data network elements to make the extension of an ad hoc network paralleled or nested and cascaded. The data domination layer of the universal data network provides a collaborative platform for computer-computer cooperation so that a plurality of intelligent elements can work under the uniform requirements of a user with a highest permission. The data domination layer could be used to set up corresponding data service administration users, under the user with a highest permission as required.

Main construction devices of a universal data network

1.1.1 A data relay server (hereinafter referred to as “relay”) is a multi-channel data transmission device, which forwards data to other data receivers while receiving the data so that the data can be transmitted more widely. On this basis, relevant auxiliary functions such as, temperature measurement, time marker transmission, data stream statistics and the like can be additionally provided as required. Main characteristics are as below.

1.1.1.1 The relay based on wireless data transmissions or wired data transmissions adopting various forms such as optical fibers, network cables and the like has characteristics that the data transmission manner is flexible and easy to extend.

1.1.1.2 An active relay is enabled to perform data transmission services of most intelligent device continuously under management of the data network interfaces, and has characteristics of enhancing signals and providing services for long time for local data services, which greatly improves the mobility and running durability of mobile intelligent devices so that the data can be transmitted more widely.

1.1.1.3 The relay autonomously searching for a higher-level server according to a real communication environment can be dominated by an interface to perform tree-like extension in certain levels, which functions in a way as the human capillaries do. Such complex environment extension network can be adopted to expand services to some complex environments or areas where interface devices are hard to be installed.

1.1.2 A data network interface (hereinafter referred to as “interface”) is a data forwarding and identification device, responsible for constructing a network of the data transmission layer, and data of the data transmission layer is identified by the interface whether it can access a service system of a data domination layer. Main characteristics are as below:

1.1.2.1 The interface based on wireless data transmissions or wired data transmissions including adopting various forms such as optical fibers, network cables and the like has characteristics that the data transmission manner is flexible and easy to extend.

1.1.2.2 After filtered through the interfaces, the data sent to a center can be subjected to data security measures so as to ensure the security during data transmission.

1.1.3 A synchronous processing center (hereinafter referred to as “center”) is a data forwarding and processing device, which provides corresponding services of data domination strategy and data forwarding request as well as a data security service for the present layer. Main characteristics are as below:

1.1.3.1 The center based on wireless data transmissions or wired data transmissions adopting various forms such as optical fibers, network cables and the like has characteristics that the data transmission manner is flexible and easy to extend.

1.1.3.2 In certain cases, inconvenient connection between the centers can be solved by relaying through a special data domination layer, and the center using it will control the relaying, to make it become a pseudo synchronous processing center. The relayed data must be encrypted when transmitted.

1.1.3.3 The centers may serve as resource reserve points of data processing services to provide relevant intelligent data processing services.

1.1.4 A central server is a data management device, which provides corresponding services of service registration administration, data statistics, data domination strategy decision and the like. Main characteristics are as below:

1.1.4.1 The central server can serve as a registry service center and an intelligent strategy analysis center, by which some defects of intelligent devices can be offset.

1.1.4.2 Based on a data domination layer service system that can be registered by a user, automatically or upon examination and approval, a wider range of data services can be provided.

1.1.4.3 Each entity client can register different users for different data service businesses on the basis of the data services of the users, so that the client can choose different users for data services of different requirements.

1.1.4.4 The partly combined intelligent system is dominated by a specific center (i.e. a sub synchronous processing center) that have the function of a central server, and connected with corresponding interfaces and standby channels of the relays to construct universal data network subsystems satisfying requirements of the universal data network, and at the same time, complete secure isolation of the subsystems from an extranet system. These combined intelligent systems are network subsystems of combined intelligent device systems.

1.2 A generalized computer system: the generalized computer system is a combined computer system, in which a data transmission layer formed by human-computer interaction elements provides data transmission services in an open network environment and accesses user equipment for human-computer interaction, and a data domination layer formed by intelligent elements, as a whole, provides uniform data domination capacities in a closed and independent network environment to complete intelligent services, wherein the human-computer interaction data entering and exiting from the data domination layer, has its own device information and its own user permission information indicated.

Main construction devices of a generalized computer system

1.2.1 Intelligent Elements Refer To Various computer elements installed in the data domination layer and having functions, such as control, operation and data storage.

1.2.2 Human-computer interaction elements refer to various computer elements installed in the data transmission layer for human-computer interaction and information exchange.

1.2.3 A host, data memory and other computer elements located in the data transmission layer are considered as auxiliary elements in the process of human-computer interaction, and also deemed as human-computer interaction elements. Taking a host as an example, the host is considered as an intelligent element when installed in the data domination layer under the requirements of the universal data network, and the host is deemed as a human-computer interaction element when installed in the data transmission layer.

2. Addressing strategy of a universal data network

2.1 The universal data work adopts a dual-username addressing mode, one being a network address username which represents single user equipment and one being a data service username which represents a set of user equipment using the user permission. The universal data network, through the data service username, distinguishes whether the elements in the universal data network are data domination layer elements or data transmission layer elements, and restricts the permissions of the data transmission layer elements to ensure the security of the data domination layer.

2.2 Addressing strategy of a data domination layer: the data domination layer constructs a connection network according to the network address username and addresses according to the network address username. In the process of data domination services, a data service username should be provided.

2.3 Addressing strategies of a data transmission layer: users who have been officially registered can use the registered network address username and the data service username. An unregistered intelligent terminal can be provided with an occasional network address username, which is managed by an interface, wherein the one requiring to be supported by data domination services should have a data service username.

3. Relations between a generalized computer system and a universal data network

3.1 The central server of the universal data network together with the intelligent resources of the centers is equivalent to intelligent elements of the generalized computer system, and is an assembly of main intelligent resources of the generalized computer system.

3.2 The functions such as data transmission of the centers in the universal data network together with the interfaces are equivalent to connection elements of the intelligent elements and human-computer interaction elements of the generalized computer system, and considered as a data exchange platform for human-computer interaction of the generalized computer system.

3.3 Peripherals of the data transmission layer of the universal data network are equivalent to the human-computer interaction elements of the generalized computer system and considered as the practical application of human-computer interaction of the generalized computer system. The generalized computer system can also have a large number of intelligent resources, including control, operation and data storage elements, in the data transmission layer, but these resources are deemed as the human-computer interaction elements, of which the data should carry user information indicating user permission and identity when entering or exiting from the data domination layer.

3.4 Thus, corresponding to the universal data network, the generalized computer system is also divided into a data domination layer and a data transmission layer, known as an intelligent layer and an interaction layer, in which the manner of limiting human-computer interaction in the intelligent layer functions as inhibiting hacking, which is an important method for increasing security.

4. Major features of a generalized computer system and a universal data network

4.1 Security

4.1.1 The addressing strategy adopting dual usernames is to some extent a method of network real name system, which increases the security of user data.

4.1.2 The data domination layers of both are relatively closed, and common users in the data transmission layers cannot perform operations to the data domination layers, with the operations directly orienting the original data or original program codes, enabling higher security.

4.2 Reliability

4.2.1 The universal data network can have certain self-healing property and higher reliability to some extent, depending on searching of network units and the automatic constitution.

4.2.2 The devices in the data transmission layers are easy to run and maintain, and construction devices thereof can perform the multiple plug-in or plug-out, which is relatively free, enabling higher reliability.

4.2.3 The intelligent elements in the data domination layers can be installed separately, which makes it possible for continuously-running hardware of the system to be replaced and upgraded, enabling higher reliability.

4.3 Flexibility

4.3.1 The data transmission layers of both have characteristics of open data transmission manner, flexible and wide services and easy extension. Communication of the universal data network can adopt a communication mode based on TCP/IP protocol, but not limited thereto, and can apply any recognizable communication modes. For example, the data domination layer can adopt IPV4 protocol, also can adopt IPV6 protocol, and can adopt any newly designed communication protocols as well, and due to the closed network environment, devices thereof is relatively easy to be upgraded, only upgrading communication devices in the data domination layers rather than upgrading user equipment.

4.3.2 The universal data network has “ubiquitous” open data transmission network and data domination services transmitted in a closed network, making remote intelligent services possible, and the functions of the remote intelligent services will be completed by registration. Therefore, the universal data network, on one hand, has the characteristics of the Internet for being compatible with various network connections, and on the other hand, has the characteristics of mobile phones for being connected to a network whenever and wherever and carrying identity authentication. The combined generalized computer system is convenient and flexible, can be big or small, and has various forms.

4.3.3 In the dual-username addressing strategy of the universal data network, the network address username represents single user equipment and the data service username represents a set of devices assigned with the user permission. The intelligent services will be integrated in point-point, point-set and set-set modes. Such service system has extended the single-line service to group services, allowing the generalized computer system to further improve the use efficiency of the computer hardware easily by manners such as BT, Cloud technologies, and the like.

5. The Practical Application and in the Importance of a Generalized Computer System and a Universal Data Network

5.1 The practical application of a universal data network

A system of the universal data network: a global data network constructed under the requirements of the universal data network, in which except that the data relay servers in the data transmission layer are shared, the data network interfaces and the data domination layer are constituted by parallel public data network and multiple professionalized data networks together. In additional to the two major public service systems, subsystems satisfying the requirements of the universal data network for severing corporations, families or individuals can also be present simultaneously. Furthermore, the subsystems may be paralleled, nested and cascaded in the universal data network as required. In the connection modes of the universal data network, two universal data networks connected in parallel in the data transmission layer (i.e. simultaneously connected to some local area network) are two equivalent subjects in parallel, and consider each other as the human-computer interaction element in the data transmission layer. When a universal data network B is nested into a data domination layer of a universal data network A (the data domination layer A accesses a data domination layer B through interfaces, and B is included in the data domination layer A), the universal data network A is deemed as the human-computer interaction element in the data transmission layer of the universal data network B, and the user with a highest permission in the data domination layer of the universal data network B is considered as some specific user in the data domination layer of the universal data network A, and the user can be the user with a highest permission or not. When the data transmission layer of the universal data network A is cascaded with the universal data network B (B is included in the data transmission layer A), the universal data network B is considered as the human-computer interaction element in the data transmission layer of the universal data network A.

5.1.1 The public data network is a global public data network, which is a universal data network established and managed in such a manner that communication protocol standards are established by a data network management organization and a unique fixed relay channel of the public data network is occupied, and a network under a same standard can be spontaneously established and applied by any individuals or organizations, and incorporated into the public data network after examined and approved by a public data network management organization, and subjected to the management of the data network management organization.

5.1.2 A professionalized data network is a global public data network, which is a universal data network established and managed in such a manner that data service providers establish communication protocol standards meeting businesses themselves and specific relay channels of the professionalized data network are occupied, and any individuals or organizations utilizing the professionalized data network should accept the management of the data service provider thereof and pay fees.

Since the public data network and the professionalized data network have been defined as special universal data network subsystems, in addition to the public data network and professionalized data network, the universal data network subsystems herein specifically refers to various data networks that satisfy requirements of the universal data network, such as subsystems serving corporations, families or individuals, or partly combined intelligent systems and the like, given that there's no special declarations made therein.

5.1.3 An universal data network subsystem is a regional data network, which is a data network established and managed by data network users or administors and satisfying requirements of the universal data network, and occupies standby relay channels.

5.2 The Importance of a Universal Data Network

A universal data network may replace Internet for characteristics of a large-scale universal data network, such as common characteristics of accessing of a transmission layer, security in the closed data network domination layer, the provision of intelligent services, no limitations to address allocation, supports for the generalized computer system, relatively easy upgrading or change of network communication protocols, multi-network coexistence and the like.

The large-scale universal data network is about to change the modes of network operation.

5.2.1 Common network users (i.e. mobile phone non-subscribers) are allowed to access the network whenever and wherever instead of accessing the network from a relatively fixed access point if the relays are widely distributed.

5.2.2 Services of data service providers will be changed to provide two major systems, namely, data transmission services and intelligent services, which coexist.

5.2.3 Software providers can provide software programs, and complete services for users through the universal data network, and users have no direct access to software codes, facilitating prevention of software theft.

5.2.4 Setting of multi channels (limited channels) of the relay of the universal data network allows commercial data services, besides the public data network, to compete and cooperate in a limited rang, and intelligent data services to be diversified under different service provider strategies, can enable data transmission protocols with multi-tendency, and can separately develop in the terms of security, efficiency and speed.

5.3 The practical application of a generalized computer system

5.3.1 A micro generalized computer system: a generalized computer system corresponding to individuals, i.e. a generalized computer system formed by digital wearable devices surrounding an individual (human-computer interaction elements), remote intelligent elements, micro hosts (intelligent elements), and data storage elements and satisfying the requirements of the universal data network.

5.3.2 A small generalized computer system: a generalized computer system corresponding to small areas such as families or small businesses, i.e. a generalized computer system formed by a small range of various computer input and output devices and controlled intelligent devices (human-computer interaction elements), centralized or decentralized host systems (intelligent elements) and data storage elements and satisfying requirements of the universal data network.

5.3.3 A medium generalized computer system: an exclusive generalized computer system corresponding to secrecy areas or preset areas, i.e. a generalized computer system formed by various computer input and output devices and controlled intelligent devices (human-computer interaction elements) in a preset area, centralized or decentralized host systems (intelligent elements) and data storage elements and satisfying requirements of the universal data network.

5.3.4 A large generalized computer system: a generalized computer system corresponding to a large-area range, i.e. a generalized computer system formed by large range (covering a whole region or nation or even the whole world) of various computer input and output devices and controlled intelligent devices (human-computer interaction elements), centralized or decentralized host systems (intelligent elements) and data storage elements and satisfying requirements of the universal data network. Ideally, a worldwide generalized computer system can form a macro computer under organization of a public universal data network.

5.4 The importance of a generalized computer system

5.4.1 The generalized computer system can use public human-computer interaction devices freely and conveniently with support of a portable identity authentication device (e.g. U shield or ring with an authentication chip), making the cost of public data service terminals considerably reduced and greatly accelerating development speed of being digital.

5.4.2 The generalized computer system can include intelligent service devices such as intelligent household products, intelligent wearables, and the like, allowing such intelligent devices to have wider applications with support of the universal data network.

5.4.3 The generalized computer system allows replacement and upgrading of computer devices to be smoothly and continuously performed, and plays an important role in computer systems for military, industries, space navigation, etc. having special requirement. If an old computer is deficient in graphic calculation performance, a host for providing graphic calculation performance can be newly added, and the old host may not quit running for a while. When the system operation is transited into the new intelligent element, the old intelligent element can be remained or removed.

### BRIEF DESCRIPTION OF DRAWINGS

FIG. 1 is a schematic view of the universal data network of the present invention.

FIG. 2 is a schematic view of the generalized computer system of the present invention.

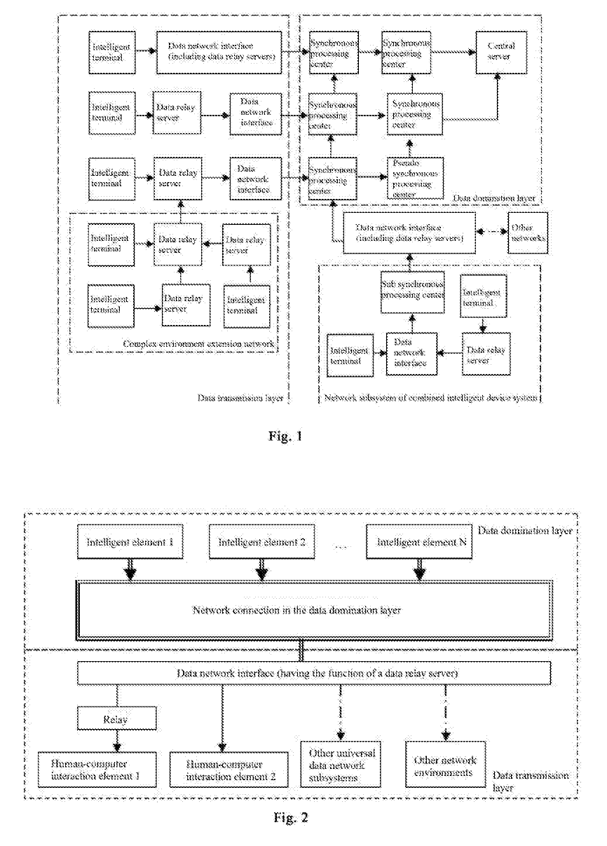

### DESCRIPTION OF DETAILED EMBODIMENTS

1. Method for constructing a universal data network

1.1 Addressing strategy of a universal data network

The universal data work adopts a dual-username addressing mode. The universal data work adopts a network address username and a data service username for addressing together. The network address username is divided into four parts, the first part being operator and registered service level permission, the second part being located area, the third part being service subject name (e.g. an area or a company), and the fourth part being a specific username. The data service username is divided into four parts, the first part being operator and registered service level permission, the second part being located area, the third part being service subject name (e.g. some communication corporation service, some game service, and some navigation service), and the fourth part being a specific username. The data service username and the network address username of the data domination layer are separated. Two usernames should be provided when using data domination services. The data service username corresponds to user permissions, the network address username corresponds to device addressing, and both of them can either be the same or different. For example, a center, of which the data service username is A123 (having user permission to use intelligent services 1, 2 and 3) and the network address username is A1, is connected to user equipment of which the data service username is B123 (having user permission to use intelligent services 1, 2 and 3) and the network address username is B1, to provide intelligent services, wherein the A1 center can, according to the permissions B123, call the A2 (executive of the intelligent service 2) center under the permissions A123 for performing data domination services, and the data is fed back to the A1 through the A2 center, forwarded to the B1 through the A1, and it is possible to directly feed the data back to the B1 through the A2, and also possible to perform a direct connection and the data transmission.

Addressing strategy of a data domination layer: The data domination layer establishes a connection network based on device hardware numbers (unchangeable), names (changeable) and network address usernames and passwords (changeable), and the data domination layer network performs addressing based on a network address username and a data service username. Addressing strategy of a data transmission layer: users who have been officially registered can use the registered network address username and the data service username. An unregistered intelligent terminal can be provided with an occasional network address username, which is managed by an interface, wherein the one requiring to be supported by data domination services should have a data service username.

1.2 The relays based on wireless data transmissions or wired data transmissions adopting various forms such as optical fibers, network cables and the like mainly perform data forwarding, and send signals to search for a higher-level relay or interface.

Detailed embodiments can refer to the following requirements.

1.2.1 A relay should be defined with multiple channels. For example, a relay is defined with eight channels, public data network management organizations and data service operators use their own respective channels, that is, channels used by the public data network management organizations and data service operators are special channels (or known as independent channels), and are connected to corresponding relay channels through interfaces, with partial standby channels reserved. Among those channels, there should be only one special channel in a public data network and at least three or more special channels in a professionalized data network, so as to respectively generate data transmission modes facilitating fast real-time requirement, efficiency requirement and security requirement of data transmission, and there should be at least two standby channels. Multi channels are realized by means of: dividing in a full-bandwidth range to obtain a plurality of channels with small bandwidth, or developing a new communication standard to form a plurality of channels, or combining a plurality of sets of network data forwarding devices. The universal data network under special security requirements can adopt a dedicated data relay server with few channels or one channel, so as to form a closed and safe universal data network. In the multi-channel relay, each channel is defined using numbers, wherein channels in the public data network and the professionalized data networks are defined using fixed numbers, and standby channels may be defined using user-defined numbers under requirements of a user, and default to last few figures of the number. Taking an eight-channel relay as an example, independent channels are channels 1-4, and standby channels are channels 5-8, and when in use, the public data network occupies the channel 1, the professionalized data networks A1, A2, B1, B2, C1, C2 and C3 occupy the channels 2, 3 and 4 separately according to classes A, B and C. Some user who uses the public data network establishes the channel numbers recognized by the public data network under the requirements of the public data network and borrows the channel 5; some user who uses the professionalized data network A1 establishes the channel numbers recognized by the professionalized data network A1 under the requirements of the professionalized data network A1 and borrows the channel 6; and some user affiliated with a universal data network subsystem establishes the channel numbers at its own discretion under the administration requirements of the universal data network subsystem and borrows the channel 5. That is, channel numbers are the actual relay channel numbers. In addition, a channel address is a logical network address of a data network relative to other data networks, each of the public data network, the professionalized data networks and the universal data network subsystems in the system of the universal data network has its own specific channel address, wherein the public data network and the professionalized data network occupy specific channels and transmit data according to corresponding channel addresses, the universal data network subsystem occupies a standby channel and transmits data according to the corresponding channel address satisfying requirements of the public data network, the professionalized data network or the universal data network subsystem, different universal data network subsystems correspond to different channel addresses, and the channel is a carrier enabling data transmission among all universal data network subsystems comprising the public data network and the professionalized data network. A channel address can adopt a form similar to IP, or a form of numbers in a long sequence. In this case, the channel address corresponds to a network data username in the universal data network.

1.2.2 The relay can adopt two sets of circuits for increasing reliability. A main circuit is randomly assigned by interfaces during specific communication and switched as required. After receiving data, the main circuit sends the same data after examined and approved by the interfaces. Data required to be encrypted and transmitted upward is transmitted to higher-level relay(s) or interface(s) via standby circuit(s). A transfer process is encrypted according to requirements of connected servers for terminal communication. If one set of the circuit malfunctions, only one normal set is used to receive and transmit data. The two sets of circuits can automatically change roles in being main or standby circuit.

1.2.3 In an intelligent terminal communication process requiring to be encrypted, it should be first connected to a center which chooses an encryption service manner, and linked to terminals.

1.2.4 In a human-computer interaction process which is in high-speed movement and crosses interfaces, it should be connected to a center which encrypts synchronously or broadcasted to relays controlled by all nearby interfaces, till to terminals.

1.2.5 When a relay cannot find an interface, it should seek other higher-level relays and indicate the level number in a subnet of the data transmission layer when accessing a network, facilitating accessing of other relays.

1.2.6 The relay can only access to one interface in a same channel. For example, if interfaces 1A, 1B, 2A, 2B capable of using channels 1, 2 nearby can be connected for an eight-channel relay, at this moment, the channels 1, 2 of the relay will separately be connected to the interfaces 1A, 2A which are easy to be connected. At this moment, the interfaces 1A, 2A each use one of the eight channels, and such connection will not influence the use of other channels.

1.2.7 When a relay receives data only forwarded in the data transmission layer, the data should be examined and approved only by one interface device and forwarded only once. At this moment, after receiving the data, the relay only forwards it to a connected interface for examination and approval. After receiving, the interface forwards the data to a lower-level relay upon examination and approval. Such data only forwarded in the data transmission layer is data packet carrying interface mark, rather than the original data when transmitted in a tree-like network managed by interfaces. Finally, after the relay receives an interface forwarding instruction, it will be only sent outward instead of repeatedly received and transmitted. For the forwarded data of the relays having been connected to other interfaces, the relay will not forward the data.

1.3 The interface based on wireless data transmissions or wired data transmissions adopting various forms such as optical fibers, network cables and the like receives data from a relay and forwards the data to a center upon examination and approval; according to a data domination strategy in the universal data network, feeds back corresponding data instructions and forwards the assigned data, or examines, approves and forwards the forwarded data of the affiliated relay; searches relays and establishes a tree-like communication network downwards; and searches a center, and upwards accesses a network layer above the center.

Detailed embodiments may refer to the following requirements.

1.3.1 Visible relays will be automatically searched. Once connection is successfully done, a relay will be used to search for other lower-level relay that have not been connected to the data network till the end or till no new relays are to be found out. When two interfaces near the same universal data network are simultaneously connected to a relay, the relay disconnects from one of the interfaces, and the selection manner can be judged on the basis of conditions such as communication situations or the number of the connected relays, and the like.

1.3.2 In the dual-username addressing mode, both the network address username and the data service username have contents of operators and permissions of registration service levels in the public data network and professionalized data network, so the dual usernames of the human-computer interaction elements can be parallelly used in a plurality of public data networks, professionalized data networks or the universal data network subsystems at the same time. However, the human-computer interaction elements should be connected to a corresponding relay channels and interfaces automatically. In other words, data of the dual usernames can be transmitted between interfaces or relay interfaces in the networks that are mutually recognized.

1.3.3 The interfaces will statistically analyze communication situations of lower-level relays and grade them into four levels, namely, excellent, good, fair and poor and then report to the center.

1.3.4 The interfaces may correspond to a plurality of relays, the number of which can be selected to control according to the levels, such as, 16 for level-1, 256 for level-2, and the like.

1.3.5 The device that requires to forward data services only in the data transmission layer should obtain a temporary or official username upon registration to prevent signals from being chaotically and repeatedly forwarded. A specific interface device should be capable of making a data forwarding rule, for example, data that controls the air conditioner in Room A can only be forwarded via the relays in Room A, with the relays in Room B not forwarding, and the relays in Room A are able not to forward data at the time when receiving the data.

1.4 A center based on wireless data transmissions or wired data transmissions adopting various forms such as optical fibers, network cables and the like receives data from interfaces, higher-level or lower-level centers and a central server in accordance with levels. The registered data domination strategy feeds back corresponding data instructions or forwards the assigned data; searches for interfaces, individual levels of centers and central server, and establishes networks in the data domination layers to the same level or a lower-level; and at the same time, stores data processing resources.

Detailed embodiments may refer to the following requirements.

1.4.1 A center can be established programmatically, and multiple layers of centers can be established in a same intelligent element.

1.4.2 A center that requires to be connected in mode of relaying should have an independent encryption process.

1.4.3 The bottom-layer center completes processes of user examination and approval and data exchange control, constructs subsystems, and is called level-1. In the same universal data network, the level-1 center can be connected to multiple interfaces, and the interfaces can be only connected to one center.

1.4.4 A level-2 center completes processes of big data identification and data encryption and decryption, and performs intensive receiving and sending in an integrated processing mode to big data not requiring real-time processing.

1.4.5 The centers of level-3 and above construct an intelligent resource pool and the data domination services of different levels. In other words, the centers of level-3 and above should have larger data storage capacity, stronger operation capacity, and other intelligent resources, and meanwhile, are the operating servers for various intelligent service programs.

1.5 The central server provides registered data domination strategies as well as relevant registration services, and establishes mesh networks for centers.

Detailed embodiments may refer to the following requirements.

1.5.1 The data domination layer has one and single user with a highest permission, and only the user is allowed to provide full intelligent services for the users in the data transmission layer, but the intelligent elements of the user with a highest permission can be installed in a split-type way and have a function of entitling to switch a subject.

1.5.2 The center connected and managed by the user with a highest permission in the data domination layer cannot be connected to another user with a highest permission and managed by it, and can be transferred to be managed by a new user with a highest permission only after original permissions have been cleaned up.

1.6 Examples similar to simplifying of the universal data network are set forth as follows:

INTERNET side of a router A is disconnected, and LAN side of the router A is connected to a host B, a mobile hard disk C and a Router D at the LAN side of the router A, wherein the host B is login-managed by a web user; the host B is able to manage the router D and be connected to the network of the LAN side of the router D; the mobile hard disk C may be login-managed by a non-administrator user identity of the host B; and the LAN side of the router D is connected to elements that can perform human-computer interactions using network data, e.g. a computer system E capable of logging in the host B using the non-administrator user identity of the host B. At this moment, the router A, the host B and the mobile hard disk C together are equivalent to the data domination layer, the router D is equivalent to the data transmission layer, and E is equivalent to the users of the universal data network. Such system has advantages that the element E can be installed randomly, elements A, B, and C can be installed randomly, and when the elements A, B, and C are big enough and the D is extremely widely distributed, the system is equivalent to an Internet with intelligent service functions. If the universal data network is required to access the Internet, it accesses the Internet by the INTERNET side of the Router A. If the computer system E is required to access the Internet and can access to the data domination layer upon being examined and approved by the router A, the E can still be used as a human-computer element. In the universal data network, the interfaces as a whole are examined and approved bilaterally and multiply, which is equivalent to the INTERNET side and the LAN side having a plurality of ports. In the examples above, the routers A and D constitute a closed network environment which uses the LAN network of the router A as an intranet and forms layered boundaries over the extranet (i.e. the INTERNET of the router A and the LAN of the router D), and when the user of the host B controls and manages the intelligent services of the intranet and controls and manages the boundary surfaces, this system is a simplified universal data network.

The relays, the interfaces, the centers and the central server can be partly or entirely combined, based on technical development and actual requirements, into one physical device (apparatus), or split into a plurality of devices according to functional requirements. For example, interfaces and relays are combined into a whole device or split and formed of a plurality of devices.

2. Method for constructing a generalized computer system

2.1 Basic requirements of elements of the generalized computer system

2.1.1 The elements of the generalized computer system should have a function of interacting with the basic data that connect to the universal data network.

2.1.2 The elements of the generalized computer system should have functions of identifying the data layer where it belongs in the universal data network and indicating its own device information and its own user permission information, and can reject the data manipulation of non-permission users when being in the data domination layer and provide human-computer interaction functions when being in the data transmission layer.

2.2 The construction of the generalized computer system can refer to the following requirements.

2.2.1 Construction of the generalized computer system should comprise making all of at least one intelligent element constituting a data domination layer, at least one interface element constituting a data transmission layer, at least one human-computer interaction element connected in a way satisfying requirements of the universal data network, and combined and installed into a same or a plurality of devices.

2.2.2 The generalized computer system can be obtained by connecting and combining elements of the universal data network with ordinary computer devices.

2.2.3 As a larger generalized computer system is a discrete distributed computer system with inside and outside layers, when the computer executes application programs, the generalized computer system relates to data transmissions between a plurality of elements. The connection management thereof can refer to the following methods: connection management for the generalized computer system may be realized by managing connection for data transmissions in multidimensional matrix mode in the data domination layer. For instance, the intelligent elements corresponding to the data domination layer are considered to be one-dimensional to obtain a Set A (A1, A2 and A3) and another element A4 outside the set; the human-computer interaction device used by a current user is considered to be one-dimensional to obtain a Set B (B1, B2 and B3) and another element B4 outside the set; the application programs or program ports permitted by user service permissions are considered to be one-dimensional to obtain a Set C (C1, C2 and C3) and another element C4 outside the set, in this way, when the data transmission requirements satisfy individual sets, data will be forwarded, otherwise, data will not be forwarded. In other words, in view of data sending, the data that are sent from the intelligent element A4 to the Set B cannot be forwarded; the request made by the human-computer element B4 will not be recognized; the data executed by the program C4 cannot be sent to any elements of the Set B; and vice versa, wherein it is a necessary condition that the multidimensional matrix data domination layer corresponds to the intelligent elements and human-computer interaction elements, and a post condition is to build up a matrix with other dimensions as required. For example, the aforesaid Set C can work only when combined with Set A, and under conditions satisfying the requirements of Sets A and B, if the conditions of the Sets A and C are satisfied, it means that the intelligent elements are called by the data domination layer according to user permissions to provide services, and thus, data are allowed to be transmitted. The generalized computer system having only one data domination layer host may not adopt such matrix connection management mode.

The embodiments above are only simplified examples of the present invention, and are not intended to limit the protection scopes of this invention. Any modifications, equivalent substitutions and improvements made in the spirit and principle of the present invention are all included in the protection scope of the invention.

1. A universal data network, wherein the universal data network is a clearly-layered data network system formed by combining a data transmission layer and a data domination layer, wherein the data transmission layer provides data transmission services in an open network environment and accesses user equipment, the data domination layer as a whole provides uniform data domination capacities in a closed and independent network environment to achieve intelligent services, and when a device in the data transmission layer has data in a range of the data domination layer, its own device information and its own user permission information are indicated.

2. The universal data network according to claim 1, wherein the universal data network is composed of the data transmission layer and the data domination layer together, the data transmission layer formed by data relay servers and data network interfaces, the data domination layer constructed by individual levels of synchronous processing centers and a central server, wherein the data domination layer has one and single user with a highest permission.

3. The universal data network according to claim 2, wherein the data relay server is a data transmission device, and the data transmission device is additionally provided, based on a request, with an auxiliary function corresponding to the request.

4. The universal data network according to claim 3, wherein the data relay server comprises a plurality of channels, and the universal data network under special security requirements uses a dedicated data relay server with few channels or a single channel, so as to form a closed and safe universal data network.

5. The universal data network according to claim 2, wherein the data network interface is a data forwarding and identification device, the data network interface is responsible for constructing a network of the data transmission layer, and data of the network of the data transmission layer is identified by the data network interface whether it can access a service system of the data domination layer.

6. The universal data network according to claim 2, wherein the synchronous processing center is a data forwarding and processing device, and the synchronous processing center provides corresponding services of data domination strategy and data forwarding request as well as a data security service for the present layer.

7. The universal data network according to claim 2, wherein the central server is a data management device, and the central server provides corresponding services of service registration administration, data statistics and data domination strategy decision.

8. The universal data network according to claim 2, wherein the data relay servers, the data network interfaces, the synchronous processing centers and the central server can be combined based on actual requirements, and the data relay servers, the data network interfaces, the synchronous processing centers and the central server can be incorporated partly or entirely into one physical device, or split into a plurality of devices in terms of function.

9. The universal data network according to claim 2, wherein the partly combined intelligent system is dominated by a specific synchronous processing center having a function of a central server, and connected with corresponding data network interfaces and standby channels of data relay servers, to construct universal data network subsystems satisfying requirements of the universal data network, and at the same time, securely complete secure isolation of the subsystems from an extranet system.

10. The universal data network according to claim 2, wherein a system of the universal data network is a combined system of data network systems, consisting of a public data network, professionalized data networks and universal data network subsystems respectively, wherein the public data network is a global public data network, which is a universal data network established and managed in such a manner that communication protocol standards are established by a data network management organization and a unique fixed data relay server channel of the public data network is occupied, and a network under a same standard can be spontaneously established and applied by any individuals or organizations, and incorporated into the public data network after examined and approved by a public data network management organization and subjected to management of the data network management organization; the professionalized data network is a global public data network, which is a universal data network established and managed in such a manner that data service providers establish communication protocol standards meeting businesses themselves and specific data relay server channels of the professionalized data network are occupied, and any individuals or organizations utilizing the professionalized data network should accept the management of the data service providers of the professionalized data network and pay fees; and the universal data network subsystem is a regional data network, which is a data network established and managed by data network users or administors and satisfying requirements of the universal data network, and occupies standby channels of the data relay server.

11. The universal data network according to any one of claims 2-10, wherein each of the public data network, the professionalized data networks and the universal data network subsystems in the system of the universal data networks has its own specific channel address, wherein the public data network and the professionalized data network occupy specific channels and transmit data according to corresponding channel addresses, the universal data network subsystem occupies a standby channel and transmits data according to the corresponding channel address satisfying requirements of the public data network, the professionalized data network or the universal data network subsystem, different universal data network subsystems correspond to different channel addresses, and the channel is a carrier enabling data transmission among all universal data network subsystems comprising the public data network and the professionalized data network, and at this moment, the channel address corresponds to a network address username in the universal data network.

12. A generalized computer system, wherein the generalized computer system is a combined computer system, in which a data transmission layer formed by human-computer interaction elements provides data transmission services in an open network environment and accesses user equipment for human-computer interaction, a data domination layer formed by intelligent elements, as a whole, provides uniform data domination capacities in a closed and independent network environment to complete intelligent services, wherein human-computer interaction data, when entering and exiting from the data domination layer, has its own device information and its own user permission information indicated.

13. The generalized computer system according to claim 12, wherein the generalized computer system comprises a micro generalized computer system, the micro generalized computer system is a generalized computer system corresponding to individuals, and the micro generalized computer system is composed of digital wearable devices surrounding an individual, remote intelligent elements, micro hosts and data storage elements.

14. The generalized computer system according to claim 12, wherein the generalized computer system comprises a small generalized computer system, the small generalized computer system is a generalized computer system corresponding to small areas, and the small generalized computer system is composed of computer input and output devices and controlled intelligent devices, centralized or decentralized host systems and data storage elements.

15. The generalized computer system according to claim 12, wherein the generalized computer system comprises a medium generalized computer system, the medium generalized computer system is an exclusive generalized computer system corresponding to secret areas or preset areas, and the medium generalized computer system is composed of various computer input and output devices and controlled intelligent devices in the preset area, centralized or decentralized host systems and data storage elements.

16. The generalized computer system according to claim 12, wherein the generalized computer system comprises a large generalized computer system, the large generalized computer system is a generalized computer system corresponding to a large-area range, and the large generalized computer system is composed of various computer input and output devices and controlled intelligent devices, centralized or decentralized host systems and data storage elements, in a range covering a whole region, nation or the whole world.

17. A method for constructing a universal data network, wherein the method comprises: establishing and managing a network of a data domination layer, and providing registered data domination strategies and related registration services by a central server; providing, by data synchronous processing centers, data domination services and managing a connection with data network interfaces of the data transmission layer; providing data forwarding services and establishing a tree-like communication network for the data transmission layer by the data network interfaces; and providing data transmission services by data relay servers, whereby a layered data network system is established to provide data transmission and domination services.

18. The method according to claim 17, wherein an addressing strategy of the universal data network is a dual-username addressing mode, in which a network address username represents single user equipment, a data service username represents a set of devices assigned with user permission, a user should have both of the network address username and the data service username simultaneously when utilizing the data domination services, the data service username corresponds to the user permission, the network address username corresponds to the equipment, and the both can either be the same or different.

19. The method according to claim 17 or 18, wherein each of a public data network, professionalized data networks and universal data network subsystems in a system of the universal data network has its own specific channel address, wherein the public data network and the professionalized data networks occupy specific channels and transmit data according to corresponding channel addresses, the universal data network subsystem occupies a standby channel and transmits data according to the corresponding channel address satisfying requirements of the public data network, the professionalized data network or the universal data network subsystem, different universal data network subsystems correspond to different channel addresses, and the channel is a carrier enabling data transmission among all universal data network subsystems comprising the public data network and the professionalized data network, and at this moment, the channel address corresponds to a network address username in the universal data network.

20. A method for constructing a generalized computer system, wherein the generalized computer system comprises at least one intelligent element constituting a data domination layer, at least one interface element constituting a data transmission layer, at least one human-computer interaction element, and three of them are connected in a way satisfying requirements of the universal data network, and can be combined and installed into a same or a plurality of devices.

21. The method according to claim 20, wherein the generalized computer system, during management, performs connection management for data transmission between the intelligent elements, the interface elements and the human-computer interaction elements in a multidimensional matrix mode.
